(19) United States
(12) Patent Application Publication
(10) Pub. No.: US 2004/0226661 A1
(43) Pub. Date: Nov. 18, 2004

(54) Temporary shade for a window

(76) Inventor: Hsin-Yun Su, Taipei Hsien (TW)

Correspondence Address: Hsin-Yun Su, 235 Chung-Ho, Box 8-24, Taipei, TW

(21) Appl. No.: 10/437,611

(22) Filed: May 15, 2003

(51) Int. Cl. E06B 3/48

(52) U.S. Cl. 160/84.04

(57) ABSTRACT

A temporary shade serves for a window. An elongate sheet has a top end, a bottom end, a plurality of equal space and parallel pleats. The pleat extends from the top end to the bottom end. The pleat has two banks of parallel via holes. A locking device is installed to the bottom end of the sheet for adjusting the length of the sheet. The locking device has a supporting element and a stop element. The supporting element has a first end and a second end. The first end is formed as a plane bottom which can not pass through the via holes of the pleat. The stop element is combined to the supporting element. The pleat can be positioned between the plane bottom and the stop element for sustaining sheet in a desired length.

### FIELD OF THE INVENTION

The present invention relates to a shade for use with permanently sealed windows, sliding glass windows and doors, casement windows and specifical to a temporary window shade which can be selectively raised to permit passage of light into a room, alternatively, which may be selectively lowered to obstruct view into a room.

### BACKGROUND OF THE INVENTION

In general, adjustable draperies and/or blinds are mounted to permanently sealed windows, sliding glass windows and doors, casement windows, and the like to selectively cover the window. However, new homes and rental properties are often unfurnished and, initially, do not include window draperies or blinds. Since draperies are somewhat expensive and are usually purchased for long-term use, homeowners and renters may take several weeks or more to actually purchase and install permanent draperies. This is especially true if the draperies are custom made. In addition, choosing permanent draperies often takes time because draperies are available in a wide variety of fabrics, designs, and color schemes. Consequently, new homeowners and renters may face both lack of privacy and an inability to block light shining through the windows for a long period of time.

The above-mentioned problems associated with uncovered windows are not restricted to new homeowners and renters. If permanent draperies need to be removed for replacement, or cleaning, home and apartment occupants must contend with lack of privacy and passage of light through the uncovered window.

### SUMMARY OF THE INVENTION

Accordingly, the primary object of the present invention is to provide a temporary shade for a window which is easily installed and can be extended in a desired length. Especially, the temporary shade of the present invention can be used to sealed windows, sliding windows and doors. Furthermore, the shade is easily operated for controlling the radiation of sunlight and for viewing the outdoor scenery.

To achieve above objects, the present invention provides a temporary shade for a window. An elongate sheet has a top end, a bottom end, a plurality of equal space and parallel pleats. The pleat extends from the top end to the bottom end. The pleat has two banks of parallel via holes. A sticking device has a sticking surface. The sticking device is arranged on the top end of the sheet. A tearable protecting strip covers the glued strip. The protecting strip has a non-sticky lower surface. When the sheet is mounted to a window, the protecting strip is torn out so as to expose the sticky surface; thus, the top end of the sheet being combined to a flat surface. A locking device is installed to the bottom end of the sheet for adjusting the length of the sheet. The locking device has a supporting element and a stop element. The supporting element has a first end and a second end. The first end is formed as a plane bottom which can not pass through the via holes of the pleat. When the second end of the supporting element is inserted into the via holes of the sheet and the plane bottom resists against one via hole at the bottom end. The stop element is combined to the supporting element. The pleat is positioned between the plane bottom and the stop element for sustaining sheet in a desired length.

The various objects and advantages of the present invention will be more readily understood from the following detailed description when read in conjunction with the appended drawing.

### BRIEF DESCRIPTION OF THE DRAWINGS

FIG. 1 is a perspective view of the temporary shade which is at a compressed stored position.

FIG. 2 is a perspective view of the temporary shade which is extended partially.

FIG. 3 is a perspective view of the temporary shade which is extended wholly.

FIG. 4 is a longitudinal cross section view where the temporary shade of the present invention is installed to a window frame.

FIG. 5 is a longitudinal cross section view showing that the temporary shade of the present invention is installed at a bottom surface of a wall.

FIG. 6 is a cross section view showing the bottom end of the sheet of the present invention, wherein the sheet is folded and is locked according to a first embodiment of the present invention.

FIG. 7 is an exploded perspective view showing the locking device in a first embodiment of the present invention.

FIG. 8 is a cross section view showing the bottom end of the sheet, wherein the sheet is folded and is locked according to a second embodiment of the present invention.

FIG. 9 is an exploded perspective view showing the locking device in the second embodiment of the present invention.

### DETAILED DESCRIPTION OF THE PREFERRED EMBODIMENTS

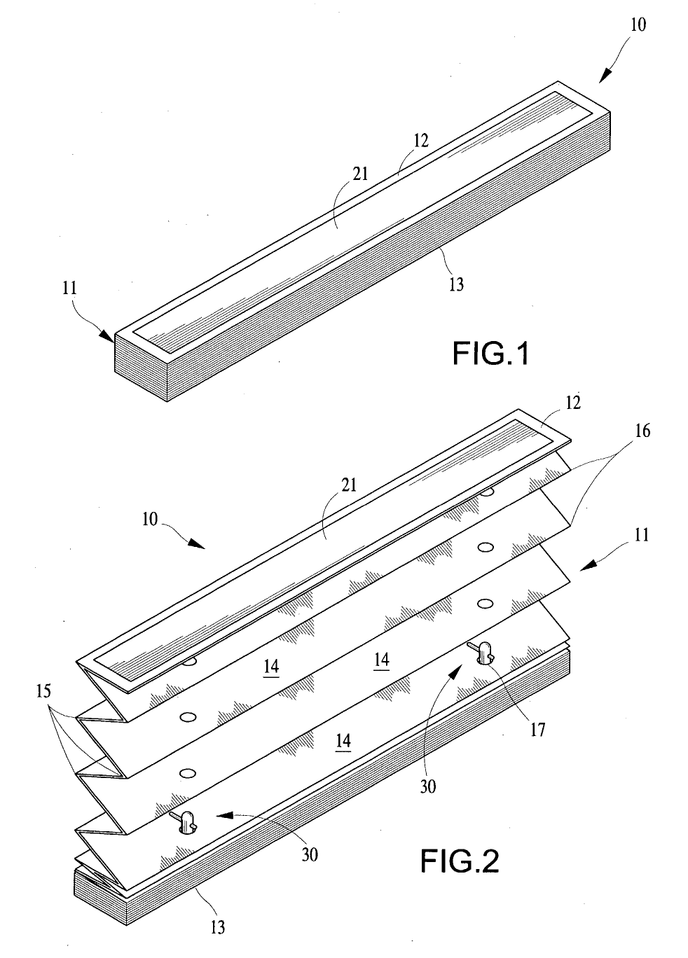

Referring to FIGS. 1 to 3, the temporary shade for a window of the present invention is illustrated. The indow shade 10 includes an elongate sheet 11. The sheet 11 has a top end 12, a bottom end 13, a plurality of equal space and parallel pleats 14. The pleats 14 extend from the front crease 15 to the rear crease 16. The sheet 11 is made of opaque paper material. Preferably, a layer of protecting layer is coated on the paper material. Moreover, the paper has a sufficient elasticity so as to assure that the pleats 14 can be used repeatedly.

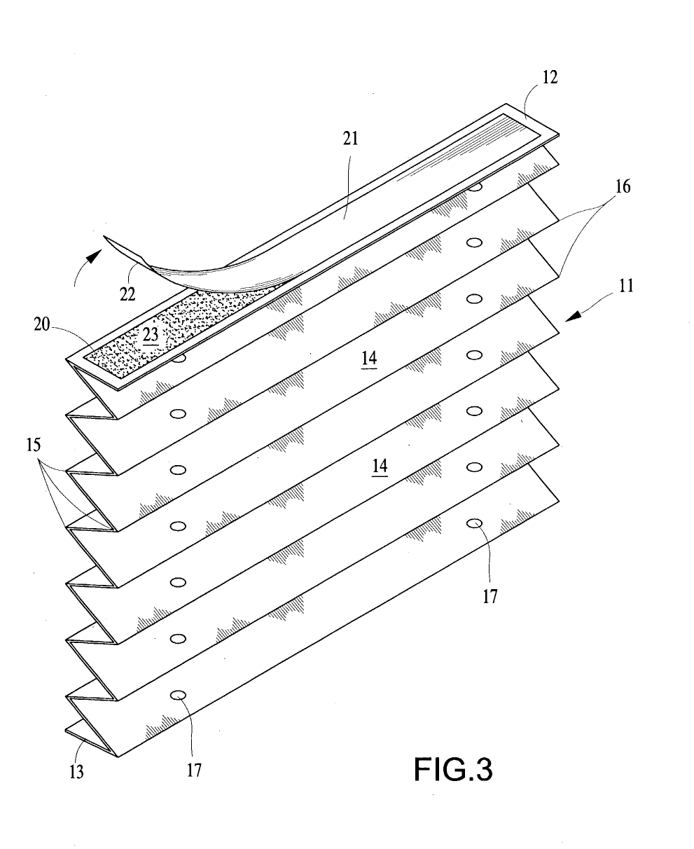

A sticky device used in the present invention is a glued strip 20 which is provided on a top end 12 of the sheet 11 so that the sheet 11 can be installed on a window or a window frame. The tearable protecting strip 21 covers the glued strip 20. The protecting strip 21 has a waxed, non-sticky lower surface. Moreover, when the sheet 11 is mounted to a window, the protecting strip 21 is torn out so as to expose the sticky surface 23, as shown in FIG. 3.

Referring to FIG. 1, the window shade 10 of the present invention can be compressed for storage or selling.

With reference to FIG. 2, a bottom distal end 13 can extend from the top end 12 freely. When the window shade 10 is mounted on a window. The sheet 11 will cause the pleats 14 to be opened vertically by the weight itself. The sheet 11 is positioned between a complete extension position (see FIG. 3) and a complete compress position (see FIG. 1). The pleat 14 has two banks of via holes 17. The via hole 17 at the bottom distal end 13 is arranged with a locking device 30 for folding and fixing the plurality of pleats 14. This way serves to adjust the length of the window shade 10.

When the sheet 11 of the window shade 10 is at a complete extension position, as shown in FIG. 3, the pleat 14 can prevent sunlight to incident into the window. If no window shade 10 exists, sunlight will radiate into the window so as to make the indoor furniture becomes worse for a long time.

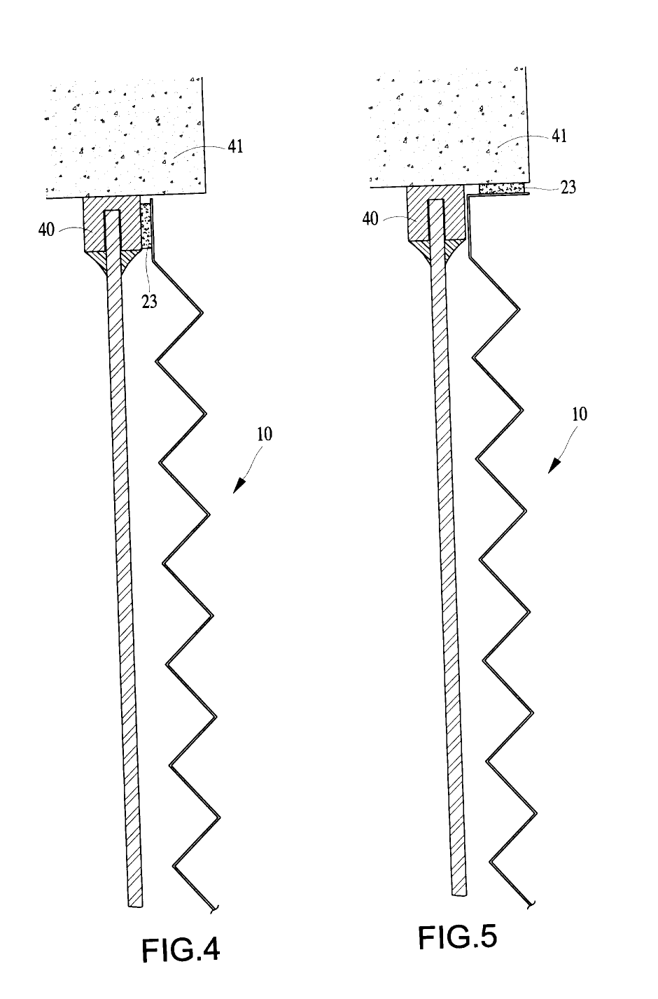

Referring to FIGS. 4 and 5, the window shade 10 of the present invention can be installed to a window frame 40 or at a bottom surface of a wall 41. By the connection of the sticking surface 23 and the window frame 40, or the bottom surface of the wall 41 or any plane of a wall. Thereby, the window shade 10 can be used to protect the privacy of the user, and selectively control the incident light.

Referring to FIGS. 6 and 7, the locking device 30 includes a cylindrical supporting element 31 and a stop element 32. The supporting element 31 has a first end 33 and a second end 34. The first end 33 is formed with a plane bottom 35. The plane bottom 35 can not pass through the via hole 17 of the pleat 14. A penetrating hole 36 is formed to be near the second end 34 of the supporting element 31.

The stop element 32 is a rod and can be inserted into the penetrating hole 36 of the supporting element 31.

When a user selects to adjust the length of the window shade 10, the second end 34 of the supporting element 31 inserts into the bottom distal end 13 so that the pleat 14 is placed on the supporting element 31. At this time, the, plane bottom 35 of the second end 34 is connected to the bottom distal end 13. Then, a stop element 32 is inserted into the via hole 17 so that the pleat 14 is between the stop element 32 and the plane bottom 35 for controlling the length of the sheet 11.

Referring to FIGS. 8 and 9, the second embodiment of the locking device of the present invention is illustrated. The locking device 50 includes a supporting element 51 and a toggle 52. The supporting element 51 is formed with a plane bottom 54. The toggle 52 is a soft rubber material. The toggle 52 has a though hole 53 which can be tightly engaged with the supporting element 51 so that the folded pleat 14 is positioned between the toggle 52 and the plane bottom 54 so as to control the extending length of the sheet 11.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A temporary shade for a window comprising:
an elongate sheet having a top end, a bottom end, a plurality of equal space and parallel pleats; the pleats extending from the top end to the bottom end; the pleat having two banks of parallel via holes;
a sticking device having a sticking surface; the sticking device being arranged on the top end of the sheet;
a tearable protecting strip covering the glued strip; the protecting strip having a non-sticky lower surface, wherein when the sheet is mounted to a window, the protecting strip is torn out so as to expose the sticky surface; thus, the top end of the sheet being combined to a flat surface; and
a locking device installed to the bottom end of the sheet for adjusting the length of the sheet; the locking device having a supporting element and a stop element; the supporting element having a first end and a second end; the first end being formed as a plane bottom which can not pass through the via holes of the pleat; when the second end of the supporting element is inserted into the via holes of the sheet, the plane bottom resists against one via hole at the bottom distal end, and the stop element is combined to the supporting element, thus, the pleat is positioned between the plane bottom and the stop element for sustaining sheet in a desired length.

2. The temporary shade for a window as claimed in claim 1, wherein the sheet is made of opaque paper which has sufficient elasticity, and thereby the pleat of the sheet is used repeatedly.

3. The temporary shade for a window as claimed in claim 1, wherein a layer of protecting glue is coated on the paper.

4. The temporary shade for a window as claimed in claim 1, wherein the supporting element has a penetrating hole near the second end of the supporting element; and the stop element is insertable into the penetrating hole.

5. The temporary shade for a window as claimed in claim 1, wherein the stop element is a rod.

6. The temporary shade for a window as claimed in claim 1, wherein the stop element is a toggle; in use, the second end of the supporting element tightly inserts into the toggle.
